(19) United States
(12) Patent Application Publication
(10) Pub. No.: US 2012/0200680 A1
(43) Pub. Date: Aug. 9, 2012

(54) Display device and method for providing 3D image of the display device

(75) Inventors: Won Wook So, Gyeonggi-do (KR); Hong Bok We, Gyeonggi-do (KR); Jong Heum Park, Gyeonggi-do (KR); Kyu Chin Kim, Gyeonggi-do (KR)

(73) Assignee: SAMSUNG ELETRO-MECHANICS CO., LTD., Suwon (KR)

(21) Appl. No.: 13/067,573

(22) Filed: Jun. 9, 2011

(30) Foreign Application Priority Data
Feb. 9, 2011 (KR) 10-2011-0011440

(51) Int. Cl. H04N 13/04

(52) U.S. Cl. 348/54; 348/E13.075

(57) ABSTRACT

Provided is a display device including: a viewpoint tracker for detecting a viewpoint variation by tracking a user's viewpoint; a display for alternately displaying a right image and a left image corresponding to user's right eye and left eye; a parallax barrier consisting of sub-segments which are continuously arranged to transmit or block the images by electrical on or off and alternately turned on/off by the unit of groups to alternately form an image transmission region and an image blocking region, in order to provide a 3D image by separately transmitting the right image and the left image to the user's right eye and left eye; and a barrier controller for electrically moving the image transmission region and the image blocking region of the parallax barrier by the unit of sub-segment according to the viewpoint variation, and a method for providing a 3D image of the display device. According to the present invention, it is possible to continuously smoothly provide an autostereoscopic 3D image to a user regardless of a change of a user's viewpoint from a mobile terminal such as a mobile phone or a change of relative position of the mobile terminal.

### CROSS-REFERENCE TO RELATED APPLICATIONS

Claim and incorporate by reference domestic priority application and foreign priority application as follows:

This application claims the benefit under 35 U.S.C. Section 119 of Korean Patent Application Serial No. 10-2011-0011440, entitled filed Feb. 9, 2011, which is hereby incorporated by reference in its entirety into this application.”

### BACKGROUND OF THE INVENTION

1. Field of the Invention

The present invention relates to a display device, and more particularly, to a display device capable of continuously smoothly providing an autostereoscopic 3D image to a user regardless of a change of a user's viewpoint from a mobile terminal such as a mobile phone or a change of relative position of the mobile terminal, and a method for providing a 3D image of the display device.

2. Description of the Related Art

In recent times, many products and technologies have been released to provide an intuitive image and a more realistic feeling to a viewer by using a stereoscopic 3D technology in TVs and game machines.

At present, the stereoscopic 3D technology introduced to the viewer mainly uses a glasses-wearing method. An active shutter type and a passive polarized type are mainly used according to an operation method of glasses or a display method of a 3D screen. Further, an autostereoscopic multi-view technology is being studied in recent times, but it is not yet commercialized.

This stereoscopic 3D image is mainly supplied to TVs and game machines and gradually continues to develop in a mobile environment. In the mobile environment, unlike TV and game machines, there are several restrictions on viewing a 3D image. First, inconvenience of wearing glasses larger than mobile devices should be removed. Second, it is impossible to continuously view a 3D image due to shaking during movement or changes of user's eyes and position of a mobile terminal.

More specifically, humans have left and right eyes which are spaced apart from each other. The left and right eyes see different 2D images of different angles. The 2D images are transmitted to the brain through the retinas of the eyes. The human brain generates a 3D image by combining two 2D images of different angles so that humans can feel a 3D effect and perspective of an object.

Since most pictures, TVs, and display devices, which have been displayed until now, show the same image on 2D planes, human's left and right eyes cannot generate a 3D image through received images. However, recently, it is possible to transmit a 3D stereoscopic image to a viewer even on a simple 2D plane by generating a left image and a right image through a stereoscopic camera and transmitting the left image and the right image to the human's left and right eyes, respectively.

These 3D display technologies may be classified into a stereoscopic type and an autostereoscopic type according to whether an observer needs to wear glasses in order to recognize a 3D image and classified into a two-view type and a multi-view type according to how many angles of 3D effects are simultaneously provided to the observer on one screen.

Here, the stereoscopic type can be subdivided into a passive polarized type, an active shutter glass type, and a chrominance type again, and the autostereoscopic type provides a 3D stereoscopic image by additionally disposing a 3D panel having a special function in front of an LCD panel which displays images and can be subdivided into a parallax barrier type and a lenticular type.

At present, since most TVs and game machines have to provide a 3D image to a plurality of viewers at the same time, they mainly use the stereoscopic type such as the active shutter glass type and the passive polarized type to stably provide a 3D stereoscopic image regardless of position of the viewers. Further, in recent times, a 3D technology is also applied to a mobile terminal such as a mobile phone to popularize the 3D technology.

Here, as described above, since it is required to consider mobility of a 3D display in a mobile terminal such as a mobile phone, it is not preferred to provide a stereoscopic 3D display such as TV. Accordingly, it is required to provide an autostereoscopic 3D display. Due to this, the lenticular lens type and the parallax barrier type are used. Since a mobile terminal has to selectively switch a 2D image with a 3D image, it is difficult to adopt the lenticular lens type. Therefore, a technology for providing a mobile 3D display to a user by using a parallax barrier type autostereoscopic 3D technology which can switch 2D and 3D is being developed.

However, a conventional parallax barrier type mobile 3D display device has disadvantages that a change of a user's viewpoint occurs in many mobile applications having a lot of movement due to a narrow viewing angle, 3D quality is deteriorated due to variety of a user's viewing angle, and user's fatigue is increased due to display of a discontinuous 3D image.

That is, referring to FIGS. 1a and 1b, the conventional mobile 3D display device has a fixed parallax barrier 10 in which light transmitting units 10a and light blocking units 10b are alternately continuously arranged. Accordingly, as shown in FIG. 1a, a right image R and a left image L of a display unit 20 are smoothly separately transmitted to user's right eye RE and left eye LE through the light transmitting units 10a of the parallax barrier 10 in a viewpoint where the user's right eye RE and left eye LE are positioned in reference points ZR0 and ZL0. As shown in FIG. 1b, in a viewpoint where the user's right eye RE and left eye LE are moved to the right from the reference points ZR0 and ZL0 to be positioned in viewpoint change points ZR1 and ZL1, the right image R and the left image L of the display unit 20 are not smoothly separately transmitted to the right eye RE and the left eye LE due to the light blocking units 10b of the parallax barrier 10 and thus they are partially provided or overlapped. Therefore, there was a problem that it was difficult to smoothly provide a 3D image to the user.

### SUMMARY OF THE INVENTION

The present invention has been invented in order to overcome the above-described problems and it is, therefore, an object of the present invention to provide a display device capable of continuously smoothly providing an autostereoscopic 3D image to a user regardless of a change of a user's viewpoint, and a method for providing a 3D image of the display device.

It is another object of the present invention to provide a display device capable of continuously smoothly providing an autostereoscopic 3D image to a user regardless of a change of relative position of a mobile terminal such as a mobile phone, and a method for providing a 3D image of the display device.

It is still another object of the present invention to provide a display device capable of improving convenience and reliability of viewpoint tracking by allowing a user to check a change of a viewpoint through a display of a mobile terminal, and a method for providing a 3D image of the display device.

In accordance with one aspect of the present invention to achieve the object, there is provided a display device including: a viewpoint tracker for detecting a viewpoint variation by tracking a user's viewpoint; a display for alternately displaying a right image and a left image corresponding to user's right eye and left eye; a parallax barrier consisting of sub-segments which are continuously arranged to transmit or block the images by electrical on or off and alternately turned on/off by the unit of groups to alternately form an image transmission region and an image blocking region, in order to provide a 3D image by separately transmitting the right image and the left image to the user's right eye and left eye; and a barrier controller for electrically moving the image transmission region and the image blocking region of the parallax barrier by the unit of sub-segment according to the viewpoint variation.

The viewpoint tracker may include a video camera which is capable of tracking the user's viewpoint.

At this time, the video camera is capable of photographing the user as well as tracking the user's viewpoint, and the display may additionally display the photographed image to the outside so that the user can check viewpoint tracking.

The display is capable of selectively displaying a 2D image. Accordingly, the user selectively may view a 3D image and a 2D image.

The barrier controller may include a viewpoint compensating unit for calculating the amount of electrical movement of the parallax barrier corresponding to the viewpoint variation.

The display device may further include a sensor for detecting a variation of relative position of the display with respect to the user's viewpoint.

At this time, the sensor may include an acceleration sensor or an angular speed sensor.

Meanwhile, the viewpoint tracker and the parallax barrier may have absolute coordinates, respectively, and it is preferred that the absolute coordinates are synchronized with each other.

In accordance with another aspect of the present invention to achieve the object, there is provided a method for providing a 3D image of a display device including: a viewpoint detection step of detecting a viewpoint variation by tracking a user's viewpoint; a viewpoint compensation step of calculating the amount of electrical movement of a parallax barrier corresponding to the detected viewpoint variation by the unit of sub-segment; and a barrier compensation step of electrically moving the parallax barrier according to the calculated amount of electrical movement.

The method for providing a 3D image of a display device may further include a coordinate setting step which is performed before the viewpoint detection step to set reference coordinates of a viewpoint tracker and reference coordinates of the parallax barrier.

At this time, the reference coordinates of the viewpoint tracker and the reference coordinates of the parallax barrier may include absolute coordinates, and the absolute coordinates of the viewpoint tracker and the parallax barrier may be synchronized with each other.

The method for providing a 3D image of a display device may further include a position variation detection step which is performed with the viewpoint detections step to detect a variation of relative position of a display with respect to the user's viewpoint.

At this time, the position variation may be detected by an acceleration sensor or an angular speed sensor.

The method for providing a 3D image of a display device may further include a photographing step which is performed with the viewpoint detection step to photograph the user and a tracking image providing step of displaying the photographed image of the user to the outside.

Meanwhile, the viewpoint variation may be detected in real time or by the unit of set section.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIGS. 1a and 1b are views for roughly explaining a conventional parallax barrier display device;

FIGS. 2a and 2b are views for roughly explaining an operation of a parallax barrier according to a change of a viewpoint of a display device in accordance with the present invention;

FIG. 3 is a configuration diagram roughly showing the display device in accordance with the present invention;

FIG. 4 is a view roughly showing viewing angles of user's right and left eyes corresponding to an electrical movement of the parallax barrier according to the change of the viewpoint of the display device in accordance with the present invention;

FIGS. 5 and 6 are a viewing angle view and a flow chart for explaining a process of calculating a movement value of the parallax barrier with respect to a variation of a user's viewpoint applied to the display device in accordance with the present invention; and

FIG. 7 is a flow chart roughly showing a method for providing a 3D image of a display device in accordance with the present invention.

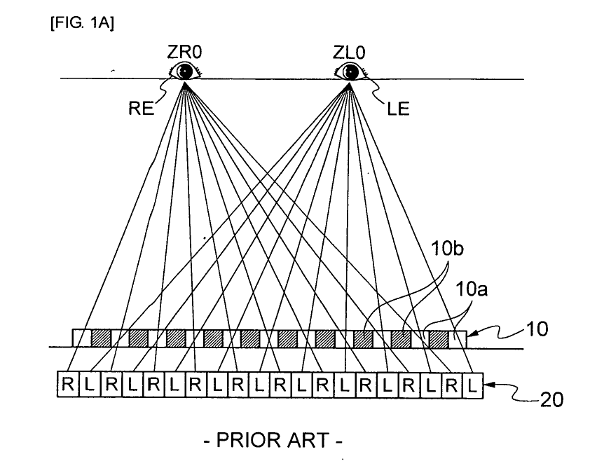

### DETAILED DESCRIPTION OF THE PREFERABLE EMBODIMENTS

Hereinafter, preferable embodiments of the present invention to specifically realize the object of the present invention will be detailed with reference to the accompanying drawings. In describing the embodiments, like names and like numerals are given to like elements and descriptions on those like elements will be omitted.

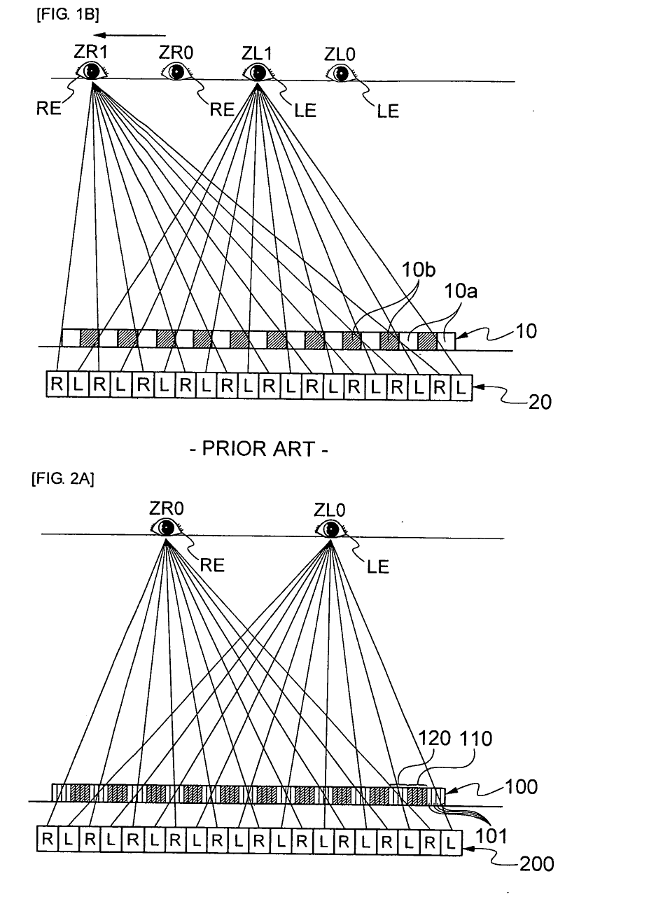

First, an embodiment of a display device in accordance with the present invention will be described in detail with reference to the accompanying FIGS. 2a to 6.

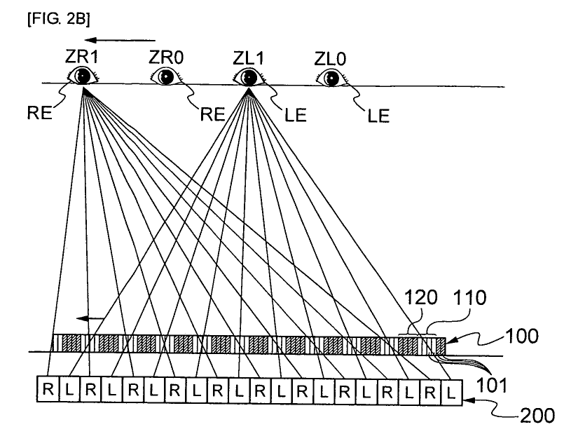

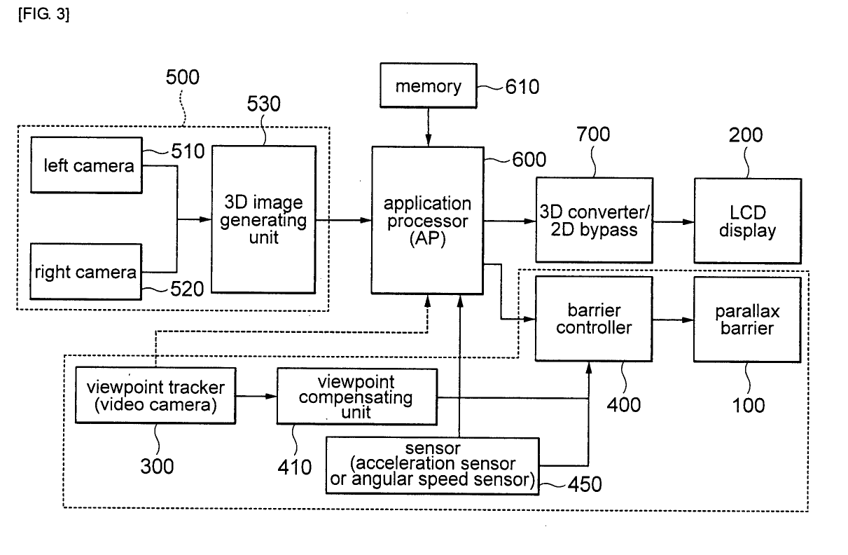

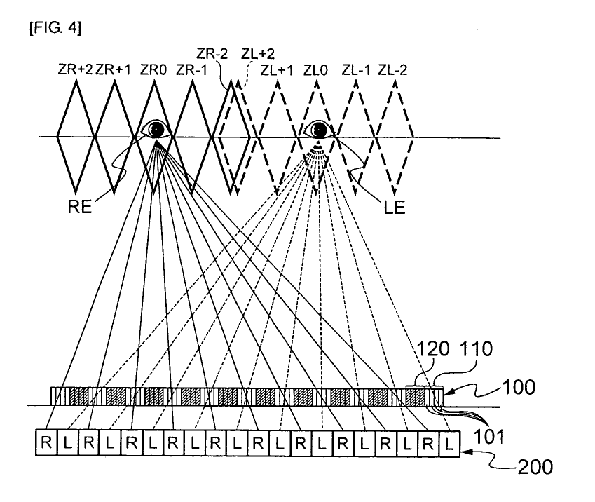

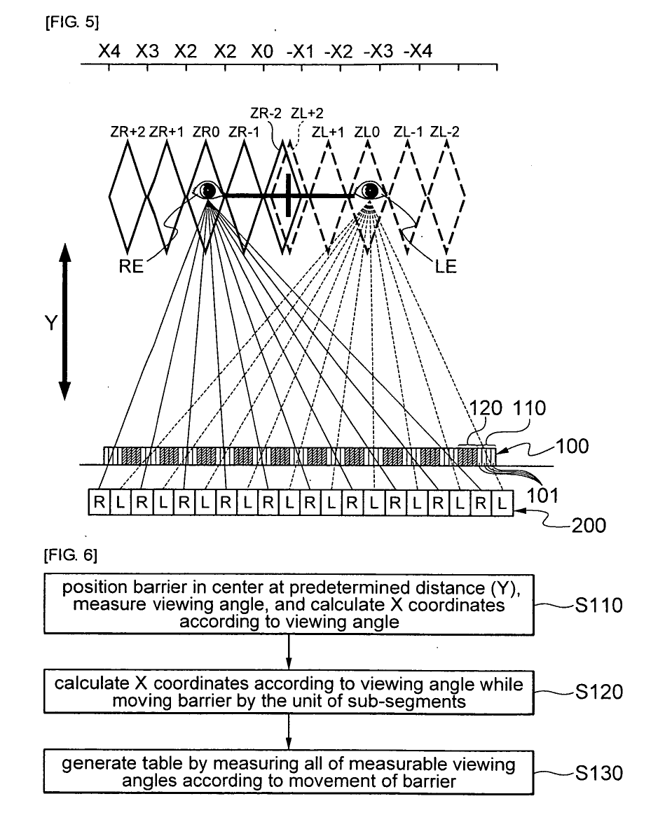

Here, FIGS. 2a and 2b are views for roughly explaining an operation of a parallax barrier according to a change of a viewpoint of a display device in accordance with the present invention. FIG. 3 is a configuration diagram roughly showing the display device in accordance with the present invention. FIG. 4 is a view roughly showing viewing angles of user's right and left eyes corresponding to an electrical movement of the parallax barrier according to the change of the viewpoint of the display device in accordance with the present invention. FIGS. 5 and 6 are a viewing angle view and a flow chart for explaining a process of calculating a movement value of the parallax barrier with respect to a variation of a user's viewpoint applied to the display device in accordance with the present invention.

Referring to FIGS. 2a and 2b, a display device in accordance with an embodiment of the present invention includes a parallax barrier 20 which is electrically moved according to a change of a user's viewpoint. Accordingly, the display device in accordance with the present embodiment can smoothly provide a 3D image to a user by accurately separately transmitting a right image R and a left image L of a display 200 to user's right eye RE and left eye LE by electrically moving the parallax barrier 100 according to a variation of the user's viewpoint to move an image transmission region 110 and an image blocking region 120 even in a changed viewpoint where the user's right eye RE and left eye LE are positioned in moving points ZR1 and ZL1 as shown in FIG. 2b by moving from a viewpoint where the user's right eye RE and left eye LE are positioned in reference points ZR0 and ZL0 as shown in FIG. 2a.

More specifically, referring to FIG. 3, the display device in accordance with the present embodiment includes the parallax barrier 100, the display 200, a viewpoint tracker 300, and a barrier controller 400.

The viewpoint tracker 300 detects a viewpoint variation by tracking the user's viewpoint. Here, the viewpoint tracker 300 is provided in the display device and may include a video camera which can track the user's viewpoint. That is, the camera for viewpoint tracking may be a video camera which is applied to a mobile terminal such as a mobile phone. The video camera can detect variations of three axes (X axis, Y axis, Z axis) of a user by tracking the user's viewpoint in real time. At this time, the viewpoint tracker 300, that is, the video camera can photograph the user as well as track the user's viewpoint. The display 200 can display user's images photographed by the video camera to the outside. Accordingly, the user can check whether viewpoint tracking is being smoothly performed and thus it is possible to improve convenience and reliability of viewpoint tracking.

The display 200 can alternately display the right image R and the left image L corresponding to the user's right eye RE and left eye LE. The parallax barrier 100 can provide the 3D image to the user by separately transmitting the right image R and the left image L to the user's right eye RE and left eye LE through the image transmission region 110 and the image blocking region 120. Here, the right image R and the left image L of the display 200 may be provided to the display 200 through a 3D image generator 500 provided in the display device of the present embodiment. That is, the 3D image generator 500 may include a left camera 510 for photographing the left image L, a right camera 520 for photographing the right image R, and a 3D image generating unit 530 for collecting the right image R and the left image L to transmit the collected images to an application processor 600. The right image R and the left image L transmitted to the application processor 600 may be alternately arranged to be output through the display 200. At this time, a 3D converter/2D bypass 700 may be provided between the application processor 600 and the display 200. Accordingly, the 3D converter/2D bypass 700 displays a 2D or 3D image through the display 200 by switching the 2D or 3D image so that the user can selectively view the 3D image and the 2D image.

In order to provide the 3D image by separately transmitting the right image R and the left image L to the user's right eye RE and left eye LE, the parallax barrier 100 may consist of sub-segments 101 which are continuously arranged to transmit or block the images by electrical on or off. The sub-segments 101 are alternately turned on/off by the unit of groups so that the above-described image transmission region 110 and the image blocking region 120 can be alternately formed.

The barrier controller 400 can electrically move the image transmission region 110 and the image blocking region 120 of the parallax barrier 100 by the unit of sub-segment 101 according to the variation of the user's viewpoint. At this time, the barrier controller 400 may include a viewpoint compensating unit 410 which calculates the amount of electrical movement of the parallax barrier 100 corresponding to the viewpoint variation.

Meanwhile, the electrical movement of the parallax controller 100 by the barrier controller 400, that is, the movement of the image transmission region 110 and the image blocking region 120 by the unit of sub-segment 101 should be performed by accurately corresponding to a change of the user's viewpoint.

More specifically, as shown in FIG. 4, each of diamond regions ZR+2, ZR+1, ZR0, ZR−1, and ZR−2 indicated by solid lines represents a viewing angle in each position with respect to the user's right eye RE, that is, a view range. Each of diamond regions ZL+2, ZL+1, ZL0, ZL−1, and ZL−2 indicated by dotted lines represents a viewing angle in each position with respect to the user's left eye LE, that is, a view range.

That is, the diamond regions ZR0 and ZL0 represent the viewing angles when the user's right eye RE and left eye LE are positioned in center points, that is, reference points. At this time, the parallax barrier 100 also is in a reference initial state, that is, in an initial state before the image transmission region 110 and the image blocking region 120 are moved. In other words, the user can smoothly view the 3D image when the user's right eye RE and left eye LE are positioned in the diamond regions ZR0 and ZL0 in the initial state of the parallax barrier 100.

And the diamond regions ZR+1 and ZL+1 represent the viewing angles at which the user can view the 3D image when the parallax barrier 100 is moved to the left by one sub-segment 101 from the initial state. The diamond regions ZR+2 and ZL+2 represent the viewing angles at which the user can view the 3D image when the parallax barrier 100 is moved to the left by two sub-segments 101 from the initial state.

Further, the diamond regions ZR−1 and ZL−1 represent the viewing angles at which the user can view the 3D image when the parallax barrier 100 is moved to the right by one sub-segment 101 from the initial state. The diamond regions ZR−2 and ZL−2 represent the viewing angles at which the user can view the 3D image when the parallax barrier 100 is moved to the right by two sub-segments 101 from the initial state.

Ultimately, when the user's viewpoint, that is, the right eye RE and the left eye LE are moved from the diamond regions ZR0 and ZL0 to the diamond regions ZR1+1 and ZL+1, the above-described viewpoint tracker 300 tracks the user's viewpoint, and the barrier controller 400 electrically moves the parallax barrier 100 by the variation of the user's viewpoint, that is, the amount of movement of the parallax barrier 100 with respect to the movement from the diamond regions ZR0 and ZL0 to ZR1+1 and ZL+1, that is, by one sub-segment 101 to the right. Accordingly, the user can smoothly view the 3D image even in the changed viewpoint by accurately separately transmitting the right image R and the left image L to the right eye RE and the left eye LE.

Here, the amount of movement of the parallax barrier 100 with respect to the variation of the user's viewpoint should be accurately calculated and may be stored in the display device as information data such as a conversion table.

More specifically, referring to FIGS. 5 and 6 and the following table 1, in the present embodiment, even through the amount of movement of the parallax barrier 100 with respect to the variation of the user's viewpoint is calculated as the conversion table based on the user's right eye RE, it is not limited thereto and the amount of movement of the parallax barrier 100 with respect to the variation of the user's viewpoint may be calculated as the conversion table based on the user's left eye LE or a center portion between the both eyes.

First, the parallax barrier 100 of the initial state is disposed at a center between the both eyes of the user in a position separated from the user by a predetermined distance, that is, about 60 to 100 cm. At this time, the viewing angle ZR0 with respect to the user's right eye RE and X coordinates X0˜X1 with respect to the viewing angle ZR0 are calculated (S110).

After that, the viewing angles with respect to the user's right eye RE and X coordinates with respect to the viewing angles are calculated while moving the parallax barrier 100 by the unit of sub-segment 101 (S120). Here, the X coordinates may have an absolute value or a relative value changed at predetermined origin coordinates.

And all of the measurable viewing angles with respect to the user's right eye RE and the X coordinates with respect to the viewing angles according to the movement of the parallax barrier 100 are calculated and converted into the conversion table like the table 1 (S130).

TABLE 1

| Based on right eye | X range | Y range | Z range |
|---|---|---|---|
| 4seg left movement | X4~X5 | Y1 | Z1 |
| 3seg left movement | X3~X4 | Y1 | Z1 |
| 2seg left movement | X2~X3 | Y1 | Z1 |
| 1seg left movement | X1~X2 | Y1 | Z1 |
| Center(reference point) | X0~X1 | Y1 | Z1 |
| 1seg right movement | −X1~X0 | Y1 | Z1 |
| 2seg right movement | −X2~X1 | Y1 | Z1 |
| 3seg right movement | −X3~X2 | Y1 | Z1 |
| 4seg right movement | −X4~X3 | Y1 | Z1 |

This conversion table, that is, matching data of the movement of the parallax barrier with respect to the change of the user's viewpoint are stored in a memory 610 (refer to FIG. 3) in a software manner as an algorithm and implemented in the display device of the present embodiment or implemented in the display device of the present embodiment in a hardware manner as a separate conversion chip or semiconductor chip.

And in the matching data of the movement of the parallax barrier with respect to the change of the user's viewpoint, the entire region of the change of the user's viewpoint is divided into detail regions. When the user's viewpoint is changed from one region to another region, the parallax barrier may be moved. The parallax barrier may be moved whenever the user's viewpoint is changed by continuously tracking the change of the user's viewpoint.

Further, in the present embodiment, even through the matching data of the movement of the parallax barrier according to the variation of the user's viewpoint with respect to one axis, that is, X axis are calculated, more accurate and excellent 3D images may be provided to the user by calculating the matching data of the movement of the parallax barrier according to the variations with respect to Y axis and Z axis in the same manner, accurately calculating the amount of electrical movement of the parallax barrier with respect to the variation of the user's viewpoint, converting the calculated amount into data, and implementing the data in the display device.

Meanwhile, referring to FIG. 3, the display device in accordance with the present embodiment may further include a sensor 450 which detects a variation of relative position of the display 200 with respect to the user's viewpoint as well as tracks the user's viewpoint. At this time, the sensor may include an acceleration sensor or an angular speed sensor.

That is, the acceleration sensor or the angular speed sensor can detect a movement variation such as tilting of a mobile terminal such as a mobile phone. It is possible to provide more accurate and excellent 3D images to the user by transmitting the variation of the relative position of the display 200 detected by the acceleration sensor or the angular speed sensor to the application processor 600 and the barrier controller 400 to compensate the electrical movement of the parallax barrier 100 with the variation of the user's viewpoint.

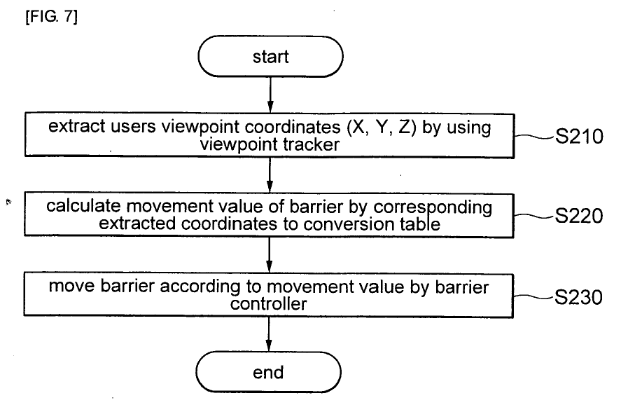

Next, a method for providing a 3D image of a display device in accordance with an embodiment of the present invention will be described with reference to FIG. 7.

FIG. 7 is a flow chart roughly showing a method for providing a 3D image of a display device in accordance with the present invention.

As shown in FIG. 7, a method for providing a 3D image of a display device in accordance with the present embodiment includes a viewpoint detection step (S210), a viewpoint compensation step (S220), and a barrier compensation step (S230).

More specifically, first, a viewpoint variation is detected by tracking a user's viewpoint through a viewpoint tracker 300 (refer to FIG. 3). That is, coordinates with respect to the user's viewpoint are detected.

And a viewpoint compensating unit 410 (refer to FIG. 3) calculates the amount of movement of a parallax barrier 100 (refer to FIG. 3) by the unit of sub-segment 101 (refer to FIG. 4), which matches with the detected coordinates with respect to the user's viewpoint.

Next, a barrier controller 400 (refer to FIG. 3) electrically moves the parallax barrier by the unit of sub-segment, that is, an image transmission region 110 (refer to FIG. 4) and an image blocking region 120 (refer to FIG. 4) by the unit of sub-segment according to the calculated amount of movement to accurately separately transmit a right image R and a left image L to a right eye RE and a left eye LE in the changed viewpoint of the user. Accordingly, it is possible to provide high quality 3D images to the user.

Meanwhile, the method for providing a 3D image of a display device of the present embodiment may further include a coordinate setting step performed before the viewpoint detection step (S210). The coordinate setting step is a step of implementing an auto-calibration function for setting reference coordinates of the viewpoint tracker 300 (refer to FIG. 3) and reference coordinates of the parallax barrier 100 (refer to FIG. 3). The reference coordinates of the viewpoint tracker and the reference coordinates of the parallax barrier may have absolute coordinates, that is, absolute values as described above. The absolute coordinates of the viewpoint tracker and the parallax barrier are synchronized with each other so that the variation of the user's viewpoint through the viewpoint tracker can be accurately applied to the amount of electrical movement of the parallax barrier to compensate the amount of electrical movement of the parallax barrier later.

And the method for providing a 3D image of a display device of the present embodiment may further include a position variation detection step performed with the viewpoint detection step. The position variation detection step is a step of detecting a variation of relative position of a display with respect to the user's viewpoint. At this time, the position variation may be detected by an acceleration sensor or an angular speed sensor.

The variation of the relative position of the display detected by the acceleration sensor or the angular speed sensor is used to compensate the electrical movement of the parallax barrier 100 with the variation of the user's viewpoint. Accordingly, it is possible to provide more accurate and high quality 3D images to the user.

Further, the method for providing a 3D image of a display device of the present embodiment may further include a user photographing step performed with the viewpoint detection step and a tracking image providing step. That is, a video camera, as an example of the viewpoint tracker, photographs the user. The display 200 (refer to FIG. 3) displays the photographed image of the user to the outside. Accordingly, the user can check whether viewpoint tracking is being smoothly performed and thus it is possible to improve convenience and reliability of viewpoint tracking.

As described above, according to the display device and the method for providing a 3D image of the display device in accordance with the present invention, there is an advantage that it is possible to continuously smoothly provide an autostereoscopic 3D image to a user regardless of a change of a user's viewpoint.

Further, according to the display device and the method for providing a 3D image of the display device in accordance with the present invention, there is an advantage that it is possible to continuously smoothly provide an autostereoscopic 3D image to a user regardless of a change of relative position of a mobile terminal such as a mobile phone.

Further, according to the display device and the method for providing a 3D image of the display device in accordance with the present invention, there is an advantage that it is possible to improve convenience and reliability of viewpoint tracking by allowing a user to check a change of a viewpoint through a display of a mobile terminal in real time.

Although the preferable embodiments of the present invention have been shown and described, it will be appreciated by those skilled in the art that various substitutions, modifications and variations may be made in these embodiments without departing from the principles and spirit of the general inventive concept, the scope of which is defined in the appended claims and their equivalents.

What is claimed is:

1. A display device comprising:
a viewpoint tracker for detecting a viewpoint variation by tracking a user's viewpoint;
a display for alternately displaying a right image and a left image corresponding to user's right eye and left eye;
a parallax barrier consisting of sub-segments which are continuously arranged to transmit or block the images by electrical on or off and alternately turned on/off by the unit of groups to alternately form an image transmission region and an image blocking region, in order to provide an 3D image by separately transmitting the right image and the left image to the user's right eye and left eye; and
a barrier controller for electrically moving the image transmission region and the image blocking region of the parallax barrier by the unit of sub-segment according to the viewpoint variation.

2. The display device according to claim 1, wherein the viewpoint tracker comprises a video camera which is capable of tracking the user's viewpoint.

3. The display device according to claim 2, wherein the video camera is capable of photographing the user as well as tracking the user's viewpoint and the display additionally displays the photographed image to the outside so that the user can check viewpoint tracking.

4. The display device according to claim 1, wherein the display is capable of selectively displaying a 2D image.

5. The display device according to claim 1, wherein the barrier controller comprises a viewpoint compensating unit which calculates the amount of electrical movement of the parallax barrier corresponding to the viewpoint variation.

6. The display device according to claim 1, further comprising:
a sensor for detecting a variation of relative position of the display with respect to the user's viewpoint.

7. The display device according to claim 6, wherein the sensor comprises an acceleration sensor or an angular speed sensor.

8. The display device according to claim 1, wherein the viewpoint tracker and the parallax barrier have absolute coordinates, respectively, and the absolute coordinates are synchronized with each other.

9. A method for providing a 3D image of a display device of claim 1 comprising:
a viewpoint detection step of detecting a viewpoint variation by tracking a user's viewpoint;
a viewpoint compensation step of calculating the amount of electrical movement of a parallax barrier corresponding to the detected viewpoint variation by the unit of sub-segment; and
a barrier compensation step of electrically moving the parallax barrier according to the calculated amount of electrical movement.

10. The method for providing a 3D image of a display device according to claim 9, further comprising: a coordinate setting step which is performed before the viewpoint detection step to set reference coordinates of a viewpoint tracker and reference coordinates of the parallax barrier.

11. The method for providing a 3D image of a display device according to claim 10, wherein the reference coordinates of the viewpoint tracker and the reference coordinates of the parallax barrier comprises absolute coordinates, and the absolutes coordinates of the viewpoint tracker and the parallax barrier are synchronized with each other.

12. The method for providing a 3D image of a display device according to claim 9, further comprising: a position variation detection step which is performed with the viewpoint detection step to detect a variation of relative position of a display with respect to the user's viewpoint.

13. The method for providing a 3D image of a display device according to claim 12, wherein the position variation is detected by an acceleration sensor or an angular speed sensor.

14. The method for providing a 3D image of a display device according to claim 9, further comprising: a photographing step which is performed with the viewpoint detection step to photograph the user and a tracking image providing step of displaying the photographed image of the user.

15. The method for providing a 3D image of a display device according to claim 9, wherein the viewpoint variation is detected in real time or by the unit of set section.
